(19) United States
(12) Patent Application Publication
(10) Pub. No.: US 2024/0359976 A1
(43) Pub. Date: Oct. 31, 2024

(54) DEVICE AND METHOD FOR PLASMA-INDUCED DECOMPOSITION OF ALKANES, IN PARTICULAR METHANE, INTO CARBON AND HYDROGEN

(71) Applicant: LEIBNIZ-INSTITUT FÜR PLASMAFORSCHUNG UND TECHNOLOGIE E.V., Greifswald (DE)

(72) Inventors: Jan HUMMEL, Greifswald (DE); Dirk UHRLANDT, Greifswald (DE); Klaus-Dieter WELTMANN, Greifswald (DE); Dan KOEGLER, Greifswald (DE); Ronny BRANDENBURG, Greifswald (DE); Diego GONZALEZ, Greifswald (DE)

(73) Assignee: LEIBNIZ-INSTITUT FÜR PLASMAFORSCHUNG UND TECHNOLOGIE E.V., Greifswald (DE)

(21) Appl. No.: 18/648,357

(22) Filed: Apr. 27, 2024

(30) Foreign Application Priority Data
Apr. 27, 2023 (EP) 23170458.6

(51) Int. Cl. C01B 3/24; B01J 19/08; B04C 5/08; B04C 5/13; B04C 5/14; B04C 5/20; C09C 1/48

(52) U.S. Cl. CPC C01B 3/24; B01J 19/088; B04C 5/08; B04C 5/13; B04C 5/14; B04C 5/20; C09C 1/485; B01J 2219/0869; B01J 2219/0875; B01J 2219/0896; C01B 2203/0272; C01B 2203/049; C01B 2203/0861; C01B 2203/1241

(57) ABSTRACT

The invention relates to a device (1) for plasma-induced decomposition of alkanes, particularly of methane, into carbon and hydrogen, comprising:
a cyclone separator (2) comprising a process chamber (3) extending about a vertical axis (H) and comprising at least one gas inlet (4) designed such that introduced alkane-containing gas circulates about the vertical axis (H) of the process chamber (3), as well as
a plasma device (5) formed such that alkane contained in the alkane-containing gas is decomposed in a plasma region (6) of the process chamber (3) by means of plasma (7) into a gas comprising carbon and hydrogen, so that resublimation of the carbon to carbon particles is achieved,
   wherein the carbon particles are separable from the gas by means of the cyclone separator (2) and the plasma region (6) is located exclusively off the vertical axis (H).

The invention further relates to respective method.

The invention relates to a device and a method for the plasma-induced decomposition of alkanes, particularly methane, into carbon and hydrogen.

A number of methods have been investigated for the pyrolysis of alkanes, particularly methane, to carbon and hydrogen to bypass classic steam reforming or without the application of oxygen, and some have been developed up to pilot plants. However, no method has yet been able to establish itself on the market. The current need for such methods arises from the objective of avoiding CO₂ emissions as completely as possible and recovering carbon from alkanes in the form of a suitable recyclable material that excludes combustion. At the same time, the potential is seen to produce hydrogen from alkanes with significantly less application of electrical energy and thus more economically than through the electrolysis of water.

In the pyrolysis of alkanes, a distinction is made between purely thermal methods, catalytic methods and plasma methods. Thermal and catalytic methods with the target product H₂ have been developed up to a technology readiness level (TRL) of 4. One example is the thermal pyrolysis of methane on a coke bed, where a plasma process can optionally be used for heating.

A plasma method based on moving arcs, known as the Kvaerner method, has been developed up to TRL 8 with the aim of producing carbon black. The Kvaerner method works with rotating high-current arcs, is aimed at plant sizes with power inputs above 1 MW and—disadvantageously—cannot be scaled to small outputs. Suitable separation of the carbon from the hot reaction chamber to generate high hydrogen purities is not described in detail for the Kvaerner method, as this was not primarily developed for hydrogen production.

Various plasma processes have been extensively investigated specifically for the pyrolysis of methane to other hydrocarbons with portions of hydrogen, wherein direct current (DC) arcs, gliding arcs, spark discharges, corona discharges, dielectrically impeded discharges and microwave discharges were also considered. High conversion rates have been achieved in research work, particularly with microwave discharges (over 90%), DC arcs (80 to 90%) and low-pressure sliding arcs (75%), wherein the energy input per methane molecule differs greatly (from 1 eV for microwave discharges to 18 eV for the low-pressure process) and essentially acetylene is obtained as a product. The production of acetylene using high-voltage arcs in the so-called Hüls reactor is particularly important in industry. Applications of non-thermal discharges comprise particularly microwave discharges, dielectrically impeded discharges, pulsed high-voltage discharges and vacuum arcs for the generation of carbon-containing nanostructures.

Current research into the plasma pyrolysis of alkanes, particularly methane, to hydrogen focuses primarily on the use of sliding arcs. Examples include experiments in argon with small admixtures of methane, as well as laboratory systems with rotating electrodes, which are currently at the experimental stage. The use of rotating sliding arcs, as recently proposed for the conversion of CO₂, appears promising.

As an alternative to the Kvaerner method, the application of a water vapor plasma burner was also investigated, wherein methane flows of up to 500 slm were processed with outputs of up to 52 kW.

Various methods are therefore known for the actual decomposition process of alkanes using both thermal plasmas and non-thermal plasmas or other electrical heating methods. However, the subsequent processing of the mixture of hydrogen and carbon particles faces the problem that at low temperatures, particularly in the case of the application of non-thermal plasmas, or when the mixture is cooled below 1000 K, relevant also in the case of the application of thermal plasmas, preferential back reactions to hydrocarbons take place. These lead to impurities in the carbon obtained, to an incomplete hydrogen yield from the pyrolysis process, as well as to potential wall deposits and blockages, which hinder continuous operation.

Based on this, the present invention's objective is to provide a device as well as a method for the plasma-induced decomposition of alkanes, particularly methane, into carbon and hydrogen, which is improved with respect to the problem described above.

This objective is solved by a device for the plasma-induced decomposition of alkanes, particularly methane, into carbon and hydrogen, having the features of claim 1, as well as a respective method according to claim 13.

Advantageous embodiments of these aspects of the invention are stated in the respective sub-claims and are described below.

A first aspect of the invention relates to a device for plasma-induced decomposition of alkanes, particularly methane, into carbon and hydrogen. The device according to the invention comprises:
a cyclone separator comprising a process chamber extending about a vertical axis and comprises at least one gas inlet designed such that introduced alkane-containing, in particular methane-containing gas circulates about the vertical axis of the process chamber, as well as
a plasma device formed such that alkane contained in the alkane-containing gas, in particular methane, is decomposed in a plasma region of the process chamber by means of plasma into a gas comprising carbon and hydrogen, so that resublimation of the carbon to carbon particles is achieved,
a. wherein the carbon particles are separable from the gas by means of the cyclone separator and the plasma region is located exclusively off the vertical axis.

By formation of the plasma in the plasma region, which is located off the vertical axis, an advantageous increased interaction between the plasma and the alkane-containing gas circulating around the vertical axis is achieved. This leads to an energy-efficient heating of the alkane-containing gas and thus to a high conversion of the alkane-containing gas into the gas comprising carbon and hydrogen. In particular, the decomposition due to the efficient heating of the gas means that the hydrogen and carbon are largely separated from each other as a result of the decomposition and are no longer bound to each other.

The circulation of the gas leads to an increased residence time of the gas in the plasma region and thus to a more efficient decomposition of the alkane-containing gas to carbon and hydrogen and resublimation of the carbon to carbon particles.

By arranging the plasma region away from the vertical axis where the alkane-containing gas circulates, the plasma device is particularly designed to generate such high temperatures in the entire process chamber that back reactions of the gaseous carbon to hydrocarbons are effectively hindered in the entire process chamber, which causes and favors efficient resublimation of the gaseous carbon to carbon particles. This is particularly ensured at temperatures of over 1,000 K, especially over 2,000 K.

In the plasma region itself, the temperatures can exceed 10,000 K, so that atomic hydrogen (from approx. 3,500 K) and carbon (from approx. 6,000 K) are formed. The resublimation of the carbon from the carbon and hydrogen gas produced by interaction with the plasma begins immediately after the interaction, wherein the carbon particles are formed.

The temperatures in the process chamber are significantly influenced by the energy radiation from the plasma. Accordingly, the plasma device can act as a heating element for heating the process chamber, wherein the plasma device is particularly set up to set the temperature in the process chamber so high that back reactions of the carbon to hydrocarbons and possibly other molecular compounds are suppressed.

The cyclone separator enables carbon particles formed in the process chamber to be separated from the gas, in particular carbon particles to be separated from gaseous hydrogen.

The plasma region describes a region within the process chamber in which the plasma is formed. The plasma is used to heat the circulating alkane-containing gas in such a way that it is decomposed into the gas comprising carbon and hydrogen.

There may be several spatially separated plasma regions, wherein the individual plasma regions are located respectively off the vertical axis.

The plasma region can be located particularly eccentrically to the vertical axis.

Preferably, the alkane-containing gas is introduced into the process chamber in such a way that it is guided along an inner wall of the process chamber and thus around its vertical axis.

The process chamber and its inner wall can be designed to be rotationally symmetrical around the vertical axis.

Preferably, the plasma device is arranged or designed in such a way that the plasma generated by the plasma device and thus the plasma region is located particularly exclusively closer to the inner wall of the process chamber than to the vertical axis. Thus, the interaction between the alkane-containing gas circulating along the inner wall around the vertical axis is advantageously increased by the plasma designed in this region, which results in efficient heating and thus conversion of the alkane-containing gas.

Gas mixtures containing alkanes can also be understood as introduced alkane-containing gas, which can comprise, for example, nitrogen, hydrogen, water vapor, nitrogen monoxide, nitrogen dioxide, carbon monoxide, carbon dioxide or inert gases in addition to alkanes.

In an embodiment, the process chamber of the cyclone separator comprises a chamber section adjoining a cylindrical chamber section and tapering in the direction of a lower outlet of the process chamber. The tapered-shaped chamber section extends around the vertical axis of the process chamber so that a circulation velocity of the gas comprising carbon and hydrogen produced by the decomposition of alkanes, particularly methane, is increased in the region of the tapering chamber section along the vertical axis in the direction of a lower outlet of the process chamber. The lower outlet is arranged in the region of an end section of the tapering chamber section opposite the cylindrical chamber section. In accordance with the centrifugal force principle, the carbon, which is heavier than the hydrogen, is increasingly carried away from the vertical axis towards the inner wall of the tapering chamber section. This effect is further enhanced due to the increased circulation velocity caused by the tapering chamber section, so that the carbon is effectively separated from the hydrogen by these measures and can finally leave the process chamber gravity-driven through the lower outlet. Furthermore, the tapering chamber section or the resulting increase in the circulation velocity in the cyclone separator means that the circulating gas comprising carbon and hydrogen comprises an increased particle separation rate in the tapering chamber section compared to, for example, a non-tapered, e.g. cylindrical chamber section. In the tapering chamber section, which adjoins the cylindrical chamber section in the direction of the lower outlet, temperatures of over 1,000 K, particularly over 2,000 K, are also present due to the immediate proximity to the plasma region. The resublimation of carbon from carbon gas to carbon particles, which is promoted by such temperatures, is therefore further favored under circulation, so that larger or heavier carbon particles are formed as a result of the increased residence time, which are carried all the more strongly to the inner wall of the tapering chamber section in accordance with the centrifugal force principle. The separation of carbon and hydrogen is thus advantageously increased by the high temperatures in the cyclone separator. In addition, the high temperatures in the process chamber largely prevent recombination of carbon and hydrogen to form alkanes.

Preferably, the tapering chamber section is designed to be rotationally symmetrical in relation to the vertical axis. In other words, the tapering chamber section preferably comprises a cone or tapered shape with a circular cross-section viewed perpendicular to the vertical axis, which decreases in size along the vertical axis from the cylindrical chamber section towards the lower outlet of the process chamber.

Alternatively, elliptical cross-sections that decrease in size along the respective vertical axis in the direction of the lower outlet are also conceivable.

In a further embodiment, the lower outlet comprises or is formed by a gas-tight floodgate, wherein the floodgate is designed to discharge the carbon, particularly the carbon particles, from the process chamber. The gas-tightness advantageously ensures that the flow properties of the circulating alkane-containing gas or the gas comprising carbon and hydrogen are not affected. As a gas-tight floodgate, the lower outlet nevertheless allows carbon, particularly carbon particles, to be discharged from the process chamber as the first product of the conversion. The floodgate may, for example, comprise several cells for receiving the carbon, particularly the carbon particles, separated by the cyclone separator, wherein the cells are emptied into a subsequent carbon collection unit after a predefined period of time or as soon as a predefined quantity of carbon, particularly carbon particles, has been absorbed by the cell. A seal of the floodgate preferably ensures that there is no gas flow between an inner space of the process chamber and its external environment at any time. For example, the floodgate is a rotary valve.

In an embodiment, the device comprises an immersion tube which extends at least partially through a front side, in particular a front wall, of the process chamber into an inner space of the process chamber, so that the hydrogen released by decomposition of alkanes, in particular methane, in the process chamber can escape at least partially, in particular completely, from the process chamber through the immersion tube.

Due to its lower density compared to the carbon, particularly the carbon particles, the hydrogen advantageously rises out of the process chamber without further measures. In particular, this arrangement ensures that the carbon or carbon particles, which are heavier than the hydrogen, cannot leave the device through the immersion tube, as a result of which the hydrogen obtained and rising from the immersion tube is practically pure and contains only residual amounts of other gases. Furthermore, the immersion tube extending into the inner space of the process chamber advantageously ensures that the hydrogen or hydrogen gas present as a result of the heating of the alkane-containing gas rises out of the process chamber before it cools down in such a way that hydrogen and carbon could recombine in back reactions to form hydrocarbons. This maintains the high conversion efficiency.

In particular, it is provided that the immersion tube extends through the front side of the process chamber as well as through the cylindrical chamber section into the tapering chamber section, so that the hydrogen can escape from the tapering chamber section via the immersion tube out of the process chamber. In the tapering chamber section, the hydrogen, which is lighter than the carbon, in particular the carbon particles, is located more in the region around the vertical axis in accordance with the centrifugal force principle, while the heavier carbon, in particular the carbon particles, is carried away from the vertical axis to the outside, as described above. The arrangement of the opening of the dip tube within the tapering chamber section thus ensures that the hydrogen separated from the carbon, particularly from the carbon particles, can escape from the process chamber as a second product of the decomposition of the alkane-containing gas by rising through the dip tube out of the process chamber due to its lower density compared to the surrounding gas.

In an embodiment, the immersion tube extends along the vertical axis.

According to a further embodiment of the device, the plasma device is designed to form at least one arc which is oriented perpendicular to the direction of circulation of the circulating alkane-containing gas in order to heat it, so that the circulating alkane-containing gas passes through the arc particularly several times.

Preferably, the spatial extent of the arc defines the plasma region.

The arc can preferably be a thermal arc and thus a thermal plasma, wherein neutral particles, electrons and ions formed by impact ionization are essentially in thermal equilibrium.

According to one embodiment, the plasma device for forming the arc comprises at least one pair of electrodes, preferably four, six or eight pairs of electrodes, with two opposite electrodes respectively.

Alternatively, long, highly fluctuating arcs or arcs rotating between ring-shaped electrodes can be used. Rotating arcs can be realized particularly by means of a spatially and temporally varying magnetic field.

Consequently, an arc can be generated by applying an electrical voltage between two electrodes of the respective pair of electrodes, wherein the arc extends between the two electrodes and thus defines the plasma region. The plasma region or plasma regions thus depend particularly on the number, geometry or spatial arrangement of the electrodes in the process chamber. If the flow properties of the alkane-containing gas introduced are known, the electrode geometry can therefore be selected in such a way that the arc or several arcs designed between different pairs of electrodes extend in regions with an increased gas concentration. Preferably, the electrodes are arranged in such a way that the majority of a gas flow of the alkane-containing gas, particularly the entire gas flow, passes through the plasma region several times. For example, the gas inlet can be aligned tangentially to the inner wall of the process chamber and to the plasma region so that the gas introduced passes through the plasma region immediately after entering the process chamber. In the case of a cylindrical chamber section, several plasma regions can be arranged on the inner wall of the process chamber, for example offset by 60° or 90° to each other around the vertical axis, so that several plasma regions are passed through one after the other. In particular, the cylindrical chamber section allows the gas flow to repeatedly pass through the same plasma region or regions, which is guided through the inner wall of the process chamber on a spiral path. These measures ensure efficient heating and thus a high conversion of the alkane-containing gas introduced.

The pairs of electrodes are preferably arranged in such a way that the resulting arc is oriented transverse to the direction of circulation of the circulating alkane-containing gas.

In the event that the resulting arc essentially extends along a connecting axis connecting both electrodes of a pair of electrodes, the two electrodes of the pair of electrodes can, for example, be offset from each other along the vertical axis so that the arc essentially forms parallel to the vertical axis.

In an alternative embodiment, it is also conceivable that the electrodes are spaced apart along a perpendicular to the vertical axis so that the arc is essentially perpendicular to the vertical axis.

Furthermore, electrode arrangements are conceivable which generate an arc which is designed respectively with a spatial extension component perpendicular and a spatial extension component parallel to the vertical axis.

The plasma device can also be one or more arc torches, which generate a thermal plasma in the form of an effluent. The arc burner or arc burners are integrated into the outer wall of the chamber instead of the electrode pairs, so that the respective effluent extends into the process chamber. The effluent is then preferably oriented transverse to the direction of circulation of the circulating alkane-containing gas and in this embodiment defines the plasma region in this way. The arc torch can be operated with the alkane-containing gas itself or with an inert or non-inert additional gas. The additional gas can be, for example, nitrogen, hydrogen, water vapor, nitrogen monoxide, nitrogen dioxide, carbon monoxide and/or carbon dioxide.

In an alternative embodiment of the invention, the plasma device is designed to generate a sliding arc. In this case, the plasma is preferably a non-thermal plasma, wherein electrons and ions are not in thermal equilibrium. In this case, one or more sliding arcs of sufficient power are integrated or a respective power input is set so that temperatures above 1000 K are generated in the process chamber.

The plasma device can also comprise one or more microwave resonators which generate a thermal or non-thermal plasma instead of the electrode arrangements, which leads to temperatures above 1000 K in the process chamber with the respective selected power input.

It is further envisaged that the plasma device comprises at least one coil which is designed to form an inductively excited plasma. For this purpose, the coil generates a magnetic field which is designed to generate an inductively coupled plasma in the process chamber away from the vertical axis instead of the electrode arrangements, which leads to sufficiently high temperatures above 1000 K in the process chamber.

In a further embodiment of the device, the at least one gas inlet comprises a nozzle which enables the alkane-containing gas which can be introduced into the process chamber to be accelerated along the nozzle, so that the alkane-containing gas can be introduced into the process chamber through the nozzle at an accelerated rate. This advantageously increases the interaction of the introduced alkane-containing gas with the plasma, in that the introduced gas in particular repeatedly circulates around the vertical axis along the inner wall of the process chamber and thus in particular repeatedly passes through the plasma region.

According to a further embodiment, the device comprises an electrostatic precipitator with a high-voltage electrode. The high-voltage electrode can, for example, be arranged in the region of the tapering chamber section. For example, at least one segment of the inner wall in the region of the tapering chamber section can be formed by the high-voltage electrode. Alternatively, the high-voltage electrode can also be arranged on the other side of the inner wall and thus outside the process chamber. In this embodiment, the charging of carbon particles and hydrogen, or their ions, caused by the plasma further promotes the deposition of carbon particles and hydrogen. A counter electrode of the high-voltage electrode can be formed by an electrode of the electrode arrangement for forming the plasma. Alternatively, one or more counter electrodes can be arranged in the chamber wall. The immersion tube can also act as a counter electrode.

In an embodiment of the invention, the device comprises a heat exchanger which is designed to preheat alkane-containing gas before it is introduced into the process chamber, in that the heat exchanger extracts heat from the hydrogen formed in the process chamber, which is heated by means of plasma, and transfers it to the alkane-containing gas. This increases the energy efficiency of the device in an advantageous way. For example, warm hydrogen escaping from the process chamber via the immersion tube can transfer heat to the alkane-containing gas via a heat transfer medium of the heat exchanger, for example water, before it is fed into the process chamber via the gas inlet. For this purpose, the discharged hydrogen can, for example, be discharged through a first of two tubes which extend through a reservoir of the heat exchanger filled with the heat transfer medium. The second of the two tubes is then used as a supply line for the alkane-containing gas via the gas inlet into the process chamber.

A second aspect of the invention relates to a method for the plasma-induced decomposition of alkanes, particularly methane, into carbon and hydrogen. In this process, alkane-containing gas, in particular methane-containing gas, is introduced through a gas inlet into a cyclone separator with a process chamber, so that the introduced alkane-containing gas circulates about a vertical axis of the process chamber, wherein alkane contained in the alkane-containing gas, in particular methane contained in the gas, is decomposed in a plasma region of the process chamber by means of plasma into gas comprising carbon and hydrogen, so that resublimation of the carbon to form carbon particles is caused, wherein the carbon particles are separable from the gas by means of the cyclone separator and the plasma region is located exclusively off the vertical axis.

In particular, it is envisaged that the method according to the second aspect of the invention is carried out by means of a device according to the first aspect of the invention. Respectively, the embodiments of the first aspect of the invention also apply to the second aspect of the invention and vice versa.

According to an embodiment of the method, a circulation velocity of the gas comprising carbon and hydrogen produced by the decomposition of alkanes, particularly methane, is increased by means of and within a tapering chamber section of the process chamber adjoining a cylindrical chamber section along the vertical axis towards a lower outlet of the process chamber.

In a further embodiment of the method, a power input into the process chamber is adjusted via the plasma device in such a way that a temperature in the region between 1000 K and 2000 K is established in the circulating alkane-containing gas or in the circulating alkane-containing gas as well as in the gas comprising carbon and hydrogen.

In the following, an embodiment example as well as further features and advantages of the invention will be explained with reference to a FIGURE.

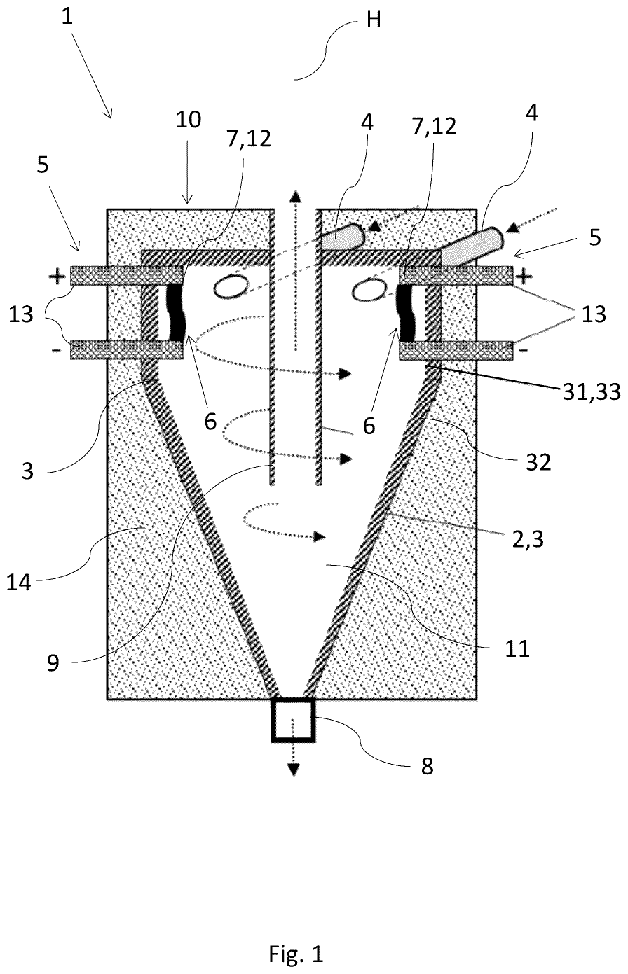

FIG. 1 shows an embodiment of the device according to the invention for the plasma-induced decomposition of alkanes, particularly methane, into carbon and hydrogen.

FIG. 1 shows an embodiment of the device 1 according to the invention for the plasma-induced decomposition of alkanes, particularly methane, into carbon and hydrogen.

The device 1 comprises a cyclone separator 2. The cyclone separator 2 comprises a process chamber 3 which extends rotationally symmetrically about a vertical axis H. A first upper segment of the process chamber 3, viewed within the plane of the drawing shown, is formed by a cylindrical chamber section 31. This is followed downwards along the vertical axis H by a tapered-shaped chamber section 32 of the process chamber 3.

In this embodiment example, two gas inlets 4 are arranged in the region of the cylindrical chamber section 31. Alkane-containing gas can be introduced into the process chamber 3 via the gas inlets 4 in such a way that it flows along an inner wall 33 of the process chamber 3, in particular an inner wall 33 of the cylindrical chamber section 31, and thus circulates around the vertical axis H. The gas inlets 4 can be nozzles, so that the alkane-containing gas is introduced into the process chamber 3 at an accelerated rate via the nozzles and is thus increasingly guided around the vertical axis H via the inner wall 33.

The device 1 also comprises a plasma device 5. In this embodiment example, the plasma device 5 comprises two pairs of electrodes which are arranged symmetrically with respect to the vertical axis H in an outer region of the cylindrical chamber section 31 of the process chamber 3 away from the vertical axis H. There may also be more than two pairs of electrodes, which are arranged particularly at 30°, 60° or 90° angles to each other offset about the vertical axis H. The electrodes 13 of the electrode pairs extend from the inner space 11 of the process chamber out of the process chamber 3 through the inner wall 33 of the process chamber, so that they can be electrically contacted from outside the process chamber 3. By applying a respective electrical voltage between the two electrodes 13 of the respective pair of electrodes, an electric arc 12 can be formed in the region between the two electrodes 13 of the respective pair of electrodes by impact ionization of the circulating alkane-containing gas, respectively. The arcs 12 form a plasma 7 with temperatures above 1,000 K, particularly above 10,000 K, in a respective plasma region 6. The plasma region 6, i.e. the region within the process chamber 3 in which the plasma 7 is formed, is determined by the geometry and relative arrangement of the electrodes 13 as well as their materials and the electrical voltages used. For example, the electrodes 13 may comprise graphite or be made of graphite. The electrodes 13 of a pair of electrodes can be spaced between 1 mm and 10 mm apart, for example. The arcs 12 can be operated with direct current or alternating current in the region of a few amperes to several hundred amperes. Alternatively, 3-phase AC operation with three or four electrodes 13 is provided. The preferred current used can be scaled with the geometric dimensions of the device 1 or the process chamber 3 as well as the distance between the electrodes 13, respectively. In other words, different dimensions of the process chamber 3 can be realized, wherein only the current used must be adapted for sufficient conversion. Exemplary dimensions of the process chamber 3 comprise a diameter perpendicular to the vertical axis H of 50 mm in the cylindrical chamber section 31 and a height of 100 mm, measured from the gas inlet 4 to the lower outlet 8.

The plasma region 6 is located exclusively away from the vertical axis H. In particular, as can be seen in FIG. 1, the plasma region 6 is located closer to the inner wall 33 of the process chamber 3 than to the vertical axis H. Due to the offset arrangement of the electrodes 13 of the respective pair of electrodes along the vertical axis H, the arcs 12 and thus the plasma region 6 are also oriented perpendicular to the direction of circulation of the alkane-containing gas circulating around the vertical axis H. These measures advantageously result in the circulating alkane-containing gas repeatedly passing through the arcs 12, whereby the alkane-containing gas within the arcs is heated to temperatures above 1,000 K, particularly above 10,000 K, in an energy-efficient manner. The associated thermal energy leads to the decomposition of the alkane-containing gas into a hot gas comprising hydrogen and carbon. In particular, the decomposition due to the efficient heating of the gas means that the hydrogen and carbon are separated from each other as a result of the decomposition and are no longer bound to each other, so that the gaseous carbon can subsequently resublimate to form carbon particles. Resublimation can already take place in the plasma region 6 and its immediate vicinity. Due to the proximity of the cyclone separator 2 to the plasma region 6, the temperatures in the entire process chamber 3 are so high that re-reactions of the gaseous carbon to hydrocarbons are effectively hindered. This is the case at temperatures of over 1,000 K, particularly over 2,000 K, and results in effective resublimation of the gaseous carbon to carbon particles. The temperatures in the process chamber are significantly influenced by the energy radiation from the plasma. Accordingly, the plasma device can act as a heating element for heating the process chamber, wherein the plasma device is particularly set up to set the temperature in the process chamber so high that re-reactions of the carbon to hydrocarbons and possibly other molecular compounds are suppressed.

As an advantageous effect in addition to decomposition into carbon, particularly into carbon particles, and hydrogen, the heating of the alkane-containing gas also contributes to an acceleration of the alkane-containing gas or the gas comprising carbon and hydrogen resulting therefrom. A possibly limited inlet rate via the gas inlets 4 or respective nozzles can therefore be compensated for by increasing the circulation velocity accordingly via the heating by the plasma device 5.

The gas inlets 4 shown in FIG. 1 comprise an angle of attack with respect to the perpendicular to the vertical axis H. Consequently, after decomposition by the plasma device 5, the hot gas comprising hydrogen and carbon, which continues to circulate around the vertical axis H, flows into the tapering chamber section 32, which in this embodiment example is designed in the shape of a funnel. The tapered shape increases the circulation velocity of the circulating gas comprising carbon and hydrogen in the region of the tapering chamber section 32 along the vertical axis H in the direction of a lower outlet 8 of the process chamber 3. In accordance with the centrifugal force principle, the carbon particles, which are heavier than the gas mixture, particularly the hydrogen, are increasingly carried away from the vertical axis H towards the inner wall 33 of the tapering chamber section 32. Finally, the carbon or carbon particles separated from the hydrogen by this measure leave the process chamber via the lower outlet 8.

The lower outlet 8 is preferably designed to be gas-tight so that it does not influence the flow properties of the alkane-containing gas or the gas comprising carbon and hydrogen that is introduced. For example, the lower outlet 8 is an floodgate, particularly a rotary valve. It is thus achieved that carbon separated from the hydrogen, in particular separated carbon particles, can be discharged from the process chamber 3 via the tapering chamber section 32 as a first product of the decomposition of the alkane-containing gas, wherein the flow properties within the process chamber 3 remain unchanged.

The device shown in FIG. 1 also comprises an immersion tube 9, which extends along the vertical axis H through an upper front side 10 of the process chamber 3 as well as through the cylindrical chamber section 31 into the tapering chamber section 32. In the tapering chamber section 32, the hydrogen, which is lighter than carbon, particularly the carbon particles, is located more strongly in the region around the vertical axis H in accordance with the centrifugal force principle, while the heavier carbon, as described above, is carried away from the vertical axis H to the outside. The arrangement of the opening of the dip tube H within the tapering chamber section 32 thus ensures that the hydrogen separated from the carbon or the carbon particles can escape from the process chamber 3 as a second product of the decomposition of the alkane-containing gas by rising out of the process chamber 3 through the dip tube 9 due to its lower density compared to the carbon or the carbon particles.

In this embodiment example, the process chamber is also surrounded by an insulating jacket 14. The insulating jacket 14 may comprise ceramic fibers, for example. This advantageously achieves sufficient thermal insulation between the inner space 11 of the process chamber 3 and its surroundings, or the surroundings of the device 14. The process chamber 3 surrounded by the insulating jacket 14 or its inner wall 33 preferably comprises a ceramic material, e.g. aluminum oxide, for sufficient heat resistance.

### LIST OF REFERENCE SYMBOLS

device 1
cyclone separator 2
process chamber 3
gas inlet 4
plasma device 5
plasma region 6
plasma 7
lower outlet 8
dip tube 9
front side 10
inner space 11
electric arc 12
electrode 13
insulating jacket 14
cylindrical chamber section 31
tapering chamber section 32
inner wall 33
vertical axis H

1. A device (1) for plasma-induced decomposition of alkanes, particularly of methane, into carbon and hydrogen, comprising:
a cyclone separator (2) comprising a process chamber (3) extending about a vertical axis (H) and comprising at least one gas inlet (4) designed such that introduced alkane-containing gas circulates about the vertical axis (H) of the process chamber (3), as well as
a plasma device (5) formed such that alkane contained in the alkane-containing gas is decomposed in a plasma region (6) of the process chamber (3) by means of plasma (7) into a gas comprising carbon and hydrogen, so that resublimation of the carbon to carbon particles is achieved,
wherein the carbon particles are separable from the gas by means of the cyclone separator (2) and the plasma region (6) is located exclusively off the vertical axis (H), where the alkane-containing gas circulates.

2. The device (1) according to claim 1, wherein the process chamber (3) of the cyclone separator (2) comprises a chamber section (32) which adjoins a cylindrical chamber section (31), tapers in the direction of a lower outlet (8) of the process chamber, is particularly tapered-shaped and extends around the vertical axis (H) of the process chamber (3), so that a circulation velocity of the gas comprising carbon and hydrogen produced by the decomposition of alkanes, in particular methane, is increased in the region of the tapering chamber section (32) along the vertical axis (H) in the direction of the lower outlet (8) of the process chamber (3), wherein the lower outlet (8) is arranged in the region of an end section of the tapering chamber section (32) opposite the cylindrical chamber section (31).

3. The device (1) according to claim 2, wherein the lower outlet (8) comprises or is formed by a gas-tight floodgate, wherein the floodgate is designed to discharge the carbon, particularly the carbon particles, from the process chamber (3).

4. The device (1) according to claim 1, wherein the device (1) comprises a dip tube (9) which extends through a front side (10) of the process chamber (3) at least partially into an inner space (11) of the process chamber (3), so that the hydrogen released by decomposition of alkanes, particularly methane, in the process chamber (3) can escape from the process chamber (3) at least partially through the dip tube (9).

5. The device (1) according to claim 4, wherein the dip tube (9) extends through the front side (10) of the process chamber (3) as well as through the cylindrical chamber section (31) into the tapering chamber section (32), so that the hydrogen from the tapering chamber section (32) can escape from the process chamber (3) via the dip tube (9).

6. The device (1) according to claim 4, wherein the dip tube (9) extends along the vertical axis (H).

7. The device (1) according to claim 1, wherein the plasma device (5) is formed to form at least one arc (12) which is oriented perpendicular to its direction of circulation for heating the circulating alkane-containing gas, so that the circulating alkane-containing gas passes through the arc (12) particularly several times.

8. The device (1) according to claim 7, wherein the plasma device (5) for forming the arc (12) comprises at least one pair of electrodes, preferably four, six, or eight pairs of electrodes, with two opposite electrodes (13) respectively.

9. The device (1) according to claim 1, wherein the plasma device (5) for generating the plasma (7) comprises one of the following: a device for generating at least one sliding arc; a microwave resonator; a coil formed to form an inductive plasma (7); an arc burner operated with the alkane-containing gas.

10. The device (1) according to claim 1, wherein the at least one gas inlet (4) comprises a nozzle which enables acceleration of the alkane-containing gas introducible into the process chamber (3) along the nozzle, so that the alkane-containing gas can be introduced into the process chamber (3) accelerated by the nozzle.

11. The device (1) according to claim 1, comprising an electrostatic precipitator which comprises a high-voltage electrode arranged particularly in the region of the tapering chamber section (32).

12. The device (1) according to claim 1, comprising a heat exchanger which is formed to preheat alkane-containing gas before it is introduced into the process chamber (3), in that the heat exchanger extracts heat from the plasma-heated hydrogen formed in the process chamber (3) and transfers it to the alkane-containing gas.

13. A method for plasma-induced decomposition of alkanes, particularly methane, into carbon and hydrogen, wherein alkane-containing gas is introduced through a gas inlet (4) into a cyclone separator (2) with a process chamber (3), so that the introduced alkane-containing gas circulates around a vertical axis (H) of the process chamber (3), wherein alkane contained in the alkane-containing gas is decomposed in a plasma region of the process chamber (3) by means of plasma (7) into gas comprising carbon and hydrogen, so that resublimation of the carbon to form carbon particles is achieved, wherein the carbon particles are separable from the gas by means of the cyclone separator and the plasma region (6) is located exclusively off the vertical axis (H), where the alkane-containing gas circulates.

14. The method according to claim 13, wherein a circulation velocity of the gas comprising carbon and hydrogen produced by the decomposition of alkanes, particularly methane, is increased along the vertical axis (H) towards a lower outlet (8) of the process chamber (3) by means of and within a tapering chamber section of the process chamber (3) adjoining a cylindrical chamber section (31).

15. The method according to claim 13, wherein a power input into the process chamber (3) via the plasma device (5) is set such that a temperature in the region between 1000 K and 2000 K is established in the circulating alkane-containing gas or in the gas comprising carbon and hydrogen.
